(19) United States
(12) Patent Application Publication
(10) Pub. No.: US 2002/0087316 A1
(43) Pub. Date: Jul. 4, 2002

(54) Computer-implemented grammar-based speech understanding method and system

(76) Inventors: Victor Wai Leung Lee, Waterloo (CA); Otman A. Basir, Kitchener (CA); Fakhreddine O. Karray, Waterloo (CA); Jiping Sun, Waterloo (CA); Xing Jing, Waterloo (CA)

Correspondence Address: John V. Biernacki, Esq., Jones, Day, Reavis & Pogue, North Point, 901 Lakeside Avenue, Cleveland, OH, 44114, US

(21) Appl. No.: 09/863,929

(22) Filed: May 23, 2001

Related U.S. Application Data
(60) Provisional application No. 60/258,911, filed on Dec. 29, 2000.

(51) Int. Cl. G10L 15/18

(52) U.S. Cl. 704/257

(57) ABSTRACT

A computer-implemented system and method for speech recognition of a user speech input that contains a request to be processed. A speech recognition engine generates recognized words from the user speech input. A grammatical models data store contains word type data and grammatical structure data. The word type data contains usage data for pre-selected words based upon the pre-selected words' usage on Internet web pages, and the grammatical structure data contains syntactic models and probabilities of occurrence of the syntactic models with respect to exemplary user speech inputs. An understanding module applies the word type data and the syntactic models to the recognized words to select which of the syntactic models is most likely to match syntactical structure of the recognized words. The selected syntactic model is then used to process the request of the user speech input.

### RELATED APPLICATION

This application claims priority to U.S. Provisional application Ser. No. 60/258,911 entitled “Voice Portal Management System and Method” filed Dec. 29, 2000. By this reference, the full disclosure, including the drawings, of U.S. Provisional application Ser. No. 60/258,911 is incorporated herein.

### FIELD OF THE INVENTION

The present invention relates generally to computer speech processing systems and more particularly, to computer systems that recognize speech.

### BACKGROUND AND SUMMARY OF THE INVENTION

Speech recognition systems are increasingly being used in telephone computer service applications because they are a more natural way for information to be acquired from and provided to people. For example, speech recognition systems are used in telephony applications where a user requests through a telephony device that a service be performed. The user may be requesting weather information to plan a trip to Chicago. Accordingly, the user may ask what is the temperature expected to be in Chicago on Monday.

However, traditional techniques for understanding the grammar (e.g., syntax and the semantics) of the user's request have been limited due to inflexibly constrained grammatical rules. In contrast, the present invention creates more flexibility by continuously updating grammatical rules from Internet web page content. The Internet web page content is continuously changing so that new content can be presented to users. The new content uses the grammar of colloquial speech to present its message to the widespread Internet community and thus is highly reflective of the grammar that may be found in a user requesting services through a telephony device. Through periodic examination of the web page content, the grammatical rules of the present invention are dynamic and evolving, which assist in correctly recognizing words.

In accordance with the teachings of the present invention, a computer-implemented system and method are provided for speech recognition of a user speech input that contains a request to be processed. A speech recognition engine generates recognized words from the user speech input. A grammatical models data store contains word type data and grammatical structure data. The word type data contains usage data for pre-selected words based upon the pre-selected words' usage on Internet web pages. The grammatical structure data contains syntactic models and probabilities of occurrence of the syntactic models with respect to exemplary user speech inputs. An understanding module applies the word type data and the syntactic models to the recognized words to select which of the syntactic models is most likely to match syntactical structure of the recognized words. The selected syntactic model is then used to process the request of the user speech input. Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a system block diagram depicting the computer and software-implemented components used to recognize user utterances;

FIG. 2 is a data structure diagram depicting the grammatical models database structure;

FIGS. 3-5 are block diagrams depicting the computer and software-implemented components used by the present invention to process user speech input with semantic and syntactic analysis;

FIG. 6 is a block diagram depicting the web summary knowledge database for use in speech recognition;

FIG. 7 is a block diagram depicting the conceptual knowledge database unit for use in speech recognition; and

FIG. 8 is a block diagram depicting the user popularity database unit for use in speech recognition.

### DETAILED DESCRIPTION OF THE PREFERRED EMBODIMENT

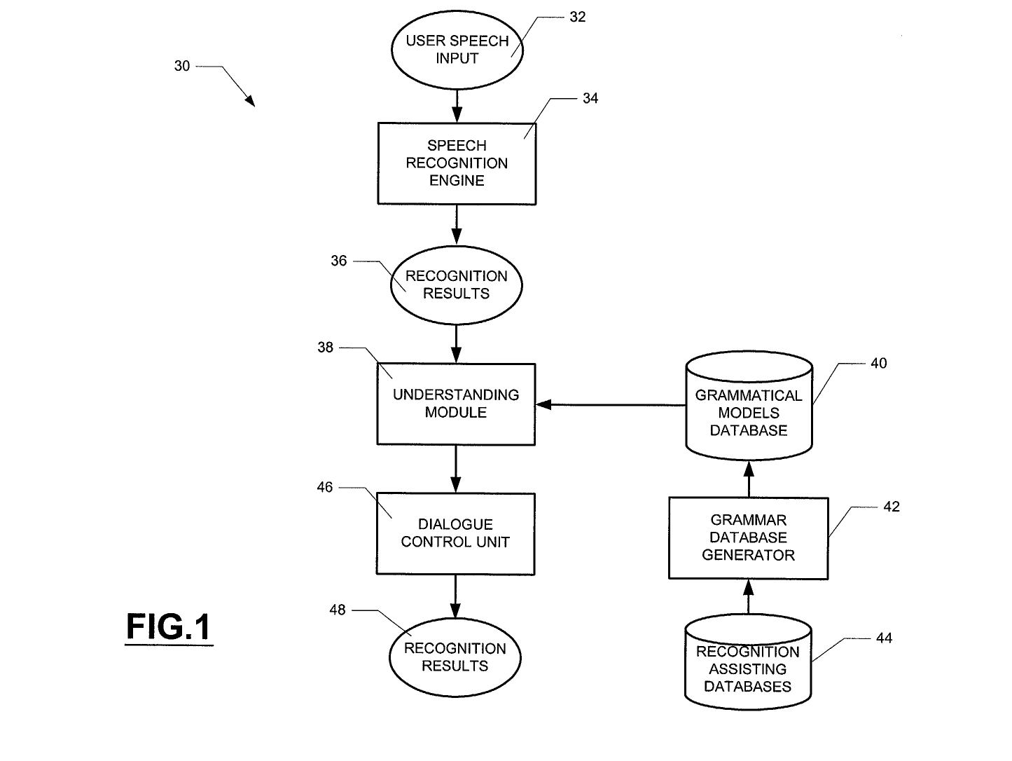

FIG. 1 depicts a grammar based speech understanding system generally at 30. The grammar based speech understanding system 30 analyzes a spoken request 32 from a user with respect to grammatical rules of syntax, parts of speech, semantics, and compiled data from previous user requests. Incorrectly recognized words are eliminated by applying the grammatical rules to the recognition results.

A speech recognition engine 34 first generates recognition results 36 from the user speech input 32 and transfers the results to a speech understanding module 38 to assist in processing the request. The understanding module 38 attempts to match the recognition results 36 to grammatical rules stored in a grammatical models database 40. The understanding module 38 uses the grammatical rules to determine which parts of the user's speech input 32 belong to which parts of speech and how individual words are being used in the context of the user's request.

The results from the understanding module 38 are sent to a dialogue control unit 46, where they are matched to an expected dialogue type (for example, the dialogue control unit 46 expects that a weather service request will follow a particular syntactical structure). If the user makes an ambiguous request, it is clarified in the dialogue control unit 46. The dialogue control unit 46 tracks the dialogue between a user and a telephony service-providing application. It uses the grammatical rules provided by the understanding module 38 to determine the action required in response to an utterance. In an embodiment of the present invention the understanding module 38 determines which grammatical rules apply for the most recently uttered phrase of the user speech input 32, while the dialogue control unit 46 analyzes the most recently uttered phrase in context of the entire conversation with the user.

The grammatical rules derived from the grammatical models database 40 include what syntactic models a user speech input 32 might resemble as well as the different meanings a word might have in the user speech input 32. A grammar database generator 42 creates the grammar rules of the grammatical models database 40. The creation is based upon word usage data stored in recognition assisting databases 44. For example, the recognition assisting databases 44 may include how words are used on Internet web pages. The grammar database generator 42 develops word usage and grammar rules from that information for storage in the grammatical models database 40.

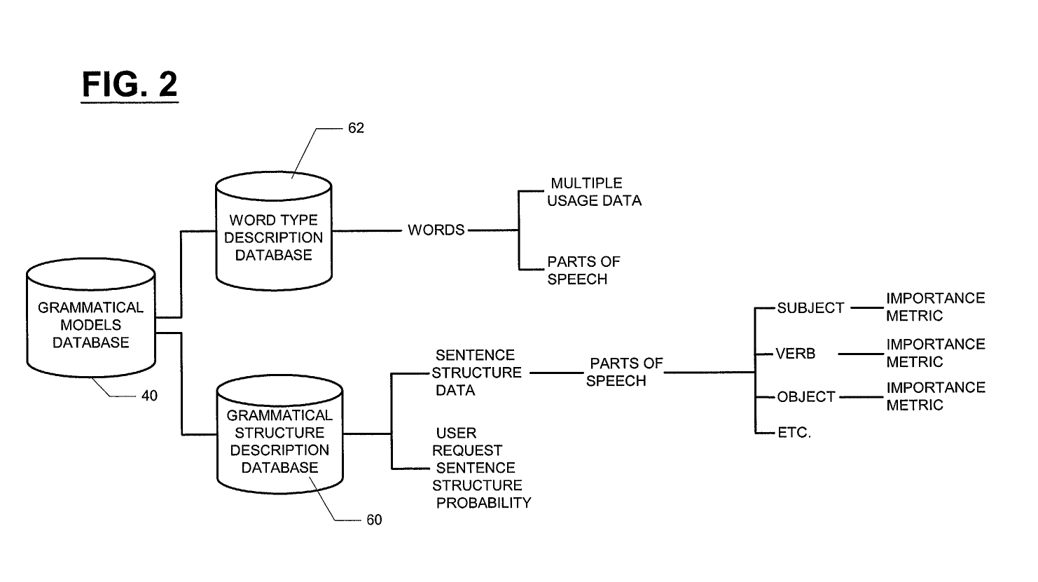

FIG. 2 depicts the structure of the grammatical models database 40. In an embodiment of the present invention, the grammatical models database 40 includes a grammatical structure description database 60 and a word type description database 62. The grammatical structure description database 60 contains information about the varieties of sentence structures and parts of speech (subject, verb, object, etc.) that have been generated from Internet web page content. Accompanying a part of speech may be an importance metric so that words appearing in different parts of speech may be weighted differently so as to enhance or diminish their recognition importance. The grammatical structure description database 60 includes the probability of any syntactical structure occurring in a user request, and aids in the understanding of speech components and in the elimination of misrecognized terms. Whereas the grammatical structure database 60 is directed at the sentence-level, the word type description database 62 is directed at the word-level and contains information about: parts of speech (noun, verb, adjective, etc.) a word may have; and whether a word has multiple usages, such as “call” which may act as either a noun or verb.

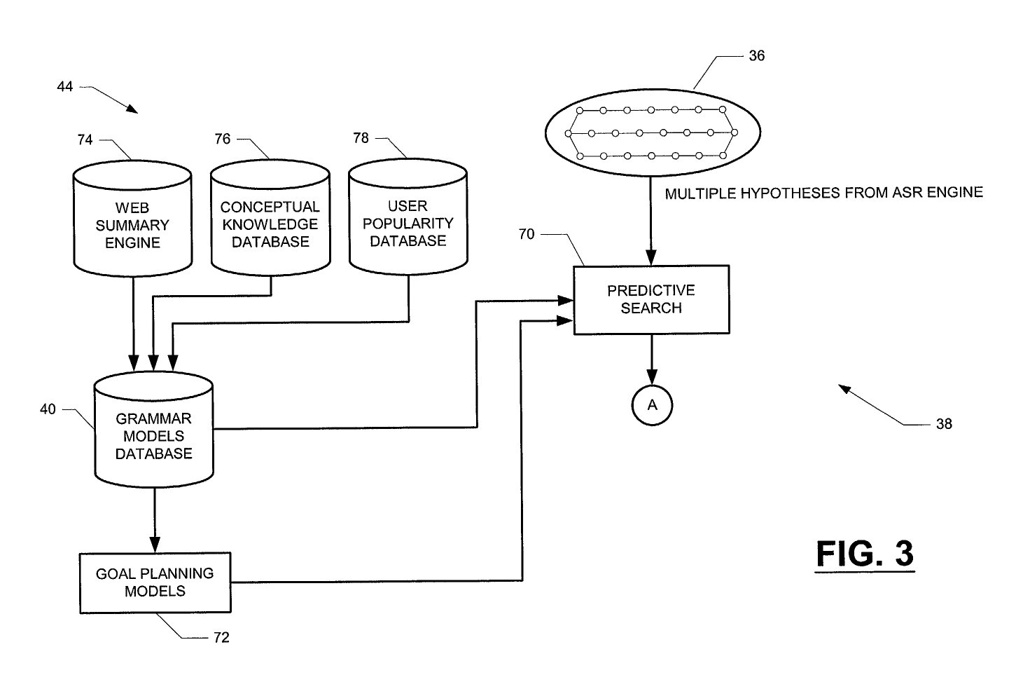

FIG. 3 depicts an example using the understanding module 38 of the present invention. Recognition results 36 from the speech recognition engine are presented to the understanding module 38 as multiple word sequences which are generally referred to as n-best hypotheses. For example the n-best hypotheses network shown at reference numeral 36 contains three series of interconnected nodes. Each series represents a hypothesis of the user input speech, and each node represents a word of the hypothesis. Without reference to the initial and terminal nodes, the first series (or hypothesis) in this example contains seven nodes (or words). The first hypothesis for the user speech input may be “give me hottest golf book from Amazon”. The second hypothesis for the user speech input contains six words and may be “give them hottest gulf from Amazon”.

The understanding module 38, using a predictive search module 70, parses the word hypotheses 36 by applying the web-derived syntactic and semantic rules of the grammar models database 40 and of goal planning models 72. The goal planning models 72 use the syntactic and semantic information in the grammar models database 40 to associate with a “goal” one or more expected syntactic and semantic structures. For example, a goal may be to call a person via the telephone. The “call” goal is associated with one or more syntactic structures that are expected when a user voices that the user wishes to place a call. An expected syntactic structure might resemble: “CALL [name of person] ON [phone type: cell, home, office]”. An expected semantic structure may have the concept “call” being highly associated with the concept “cell phone”. The more closely a hypothesis resembles one or more of the expected syntactic and semantic structures, the more likely the hypothesis is the correct recognition of the user speech input.

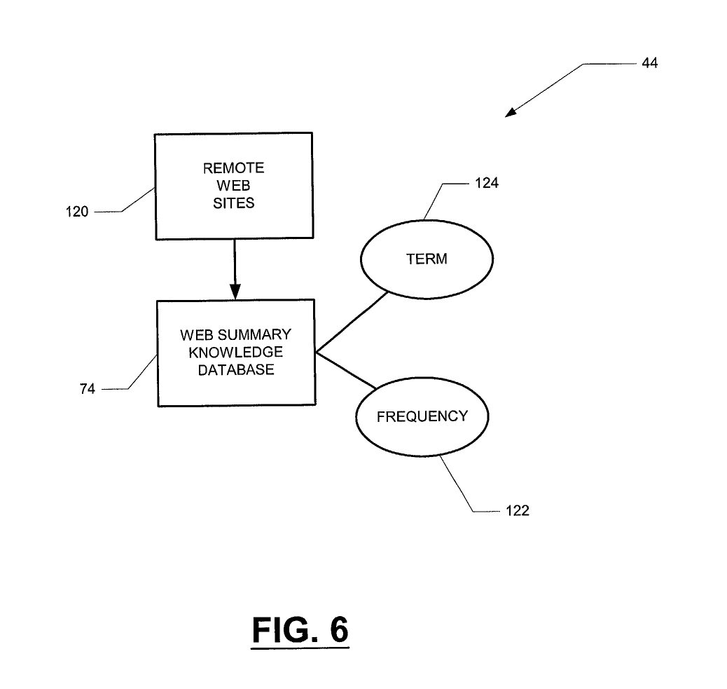

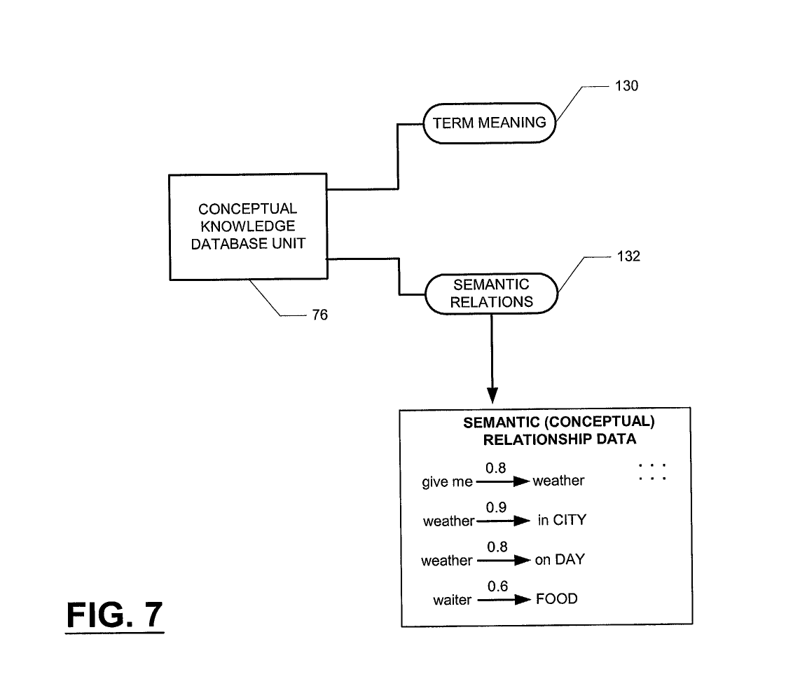

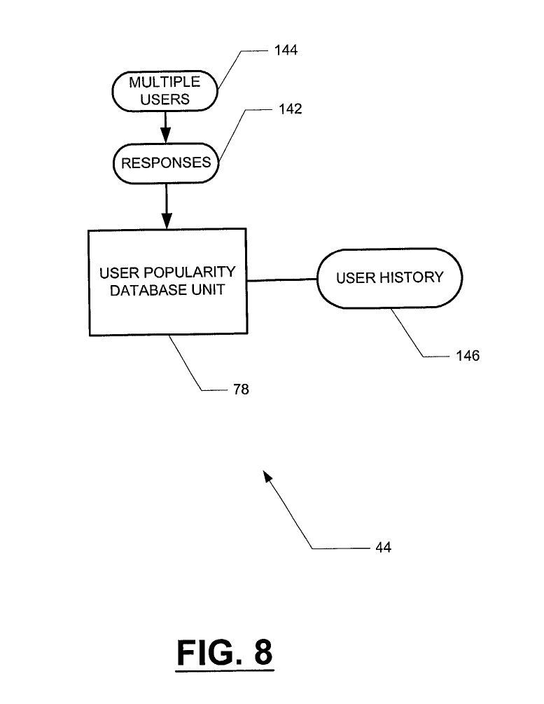

The syntactic grammar rules used in both the grammar models database 40 and the goal planning models 72 are created based upon word usage data provided by the web summary engine 74 (an example of the web summary engine 74 is shown in FIG. 6). A conceptual knowledge database 76 contains semantic relationship data between concepts. The semantic relationship data is derived from Internet web page content (an example of the conceptual knowledge database 76 is shown in FIG. 7). Previous user responses are captured and analyzed in the user popularity database 78. Words a particular user habitually uses form another basis for what words the understanding module 38 may anticipate in the user speech input (note that this database is further discussed in FIG. 8).

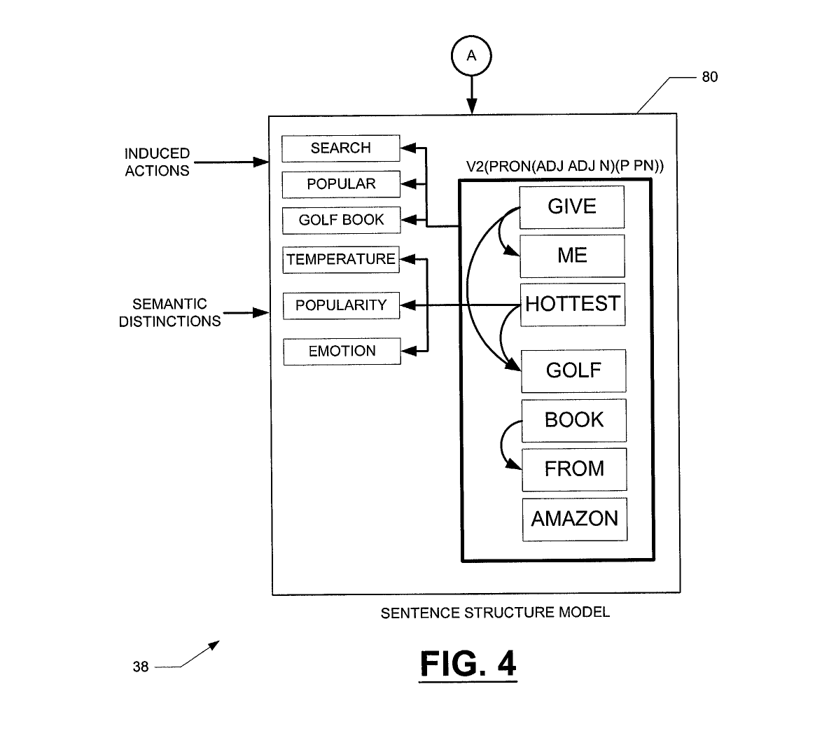

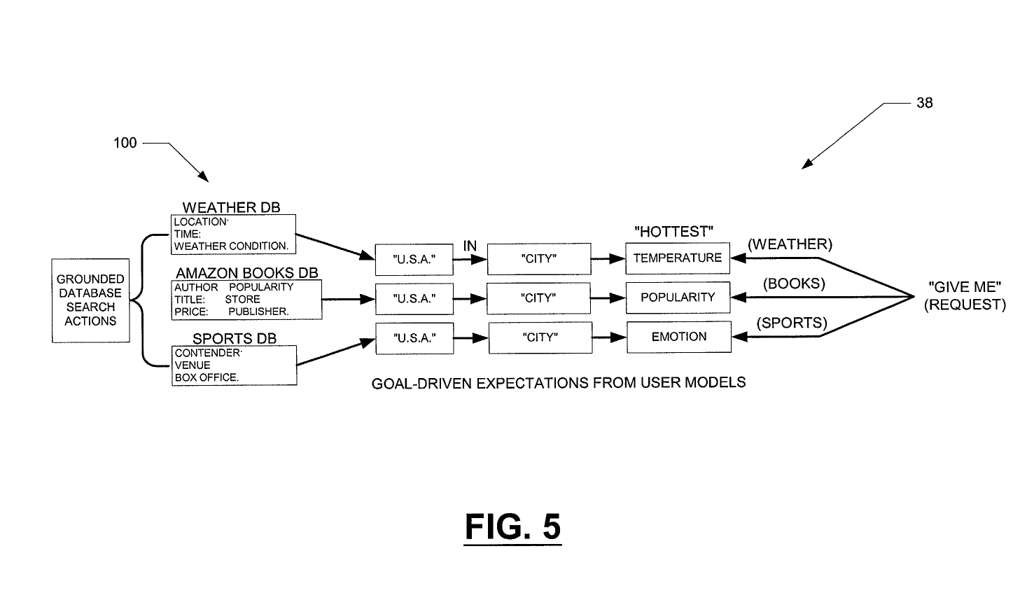

The processing performed by the predictive search module 70 is shown in FIGS. 4 and 5. With reference to FIG. 4, recognition results are parsed into a grammatical structure 80. The grammatical structure determines which parts of the user utterance belong to which part of speech categories and how individual words are being used in the context of the user's request. The grammatical structure in this example that best fits the first hypothesis is “V2(PRON(ADJ ADJ N)(P PN))”. The grammatical structure symbols represent a transitive verb (V2: “give”), a pronoun (PRON: “me”) as an object, an adjective (ADJ: “hottest”), another adjective (ADJ: “golf”), a noun (N: “book”) as another object of the verb, a preposition (P: “from”), and a proper noun (PN: “Amazon”). The term “hottest” poses a special issue because it has been detected by the present invention as having three semantic distinctions: hottest in the context of temperature; hottest in the context of popularity; and hottest in the context of emotion. After the present invention determines which meaning of the term hottest is most probable based upon the overall context, the present invention executes the requested search.

FIG. 5 depicts how the present invention determines which semantic distinction of the term “hottest” to use. This determination uses the goal planning models to better assist the parsing of recognition word sequences that sometimes only contain partially correct words. The model uses a mechanism called goal-driven expectation prediction, which puts the parsing process into a grounded discourse perspective that is based on concept detection in a user planning model. This effectively constrains possible interpretations of word meanings and user intentions. This also makes the parser more robust when words are missing.

A two-channel information flow model 100 is used to implement this function in the sense that while the parsing process goes from the beginning of the utterance towards the end, the expectation-prediction process goes backwards from the end of the utterance to the beginning to find evidence to constrain possible interpretations. The present invention includes the use of web-based, dynamically and constantly evolving rules, the database-supported grounding and two-way processing stream. For example, consider the utterance “give me hottest golf book from Amazon”. The user expectation model is revealed by the sentence-end word “Amazon”. This helps to constrain the meanings of “hottest” (as POPULARITY rather than TEMPERATURE or EMOTION) and golf (as BOOK rather than SPORT or HOBBY). As another example of this robust parsing strategy, consider an utterance with some words missed by the speech recognizer “give me cheapest [ . . . ] from, Los Angeles to [ . . . ]”. Note that the brackets indicate some false mapped words. In this way, the present invention performs “conceptual based parsing”, which means that based on the goal planning model and database grounding, the present invention returns implications rather than direct semantic meanings. As another example, consider the user input “My hard disk is full”. The surface meaning after parsing can be represented as:

[object=[HARD-DISK, owner=SPEAKER, state=FULL]]

This representation is then processed with the goal planning model being grounded by service databases (e.g., a sports information service database that may be available through the Internet). For example, if the database is an 800-number service attendant, the expectation-driven model contains an information stream directly from the database engine. In this case, one of the 800-number database could be about computer upgrading service. The concept matching assisted with the sentence structure parsing will then lead to the speech act of [SEARCH, service=PC-UPGRADING, project=HARD-DISK]. In this way, the understanding system is tightly coupled with applications' databases and returns meaningful instructions to the application system.

FIG. 6 depicts an exemplary structure of the web summary knowledge database 74. The web summary knowledge information database 74 contains terms and summaries derived from relevant web sites 120. The web summary knowledge database 74 contains information that has been reorganized from the web sites 120 so as to store the topology of each site 120. Using structure and relative link information, it filters out irrelevant and undesirable information including figures, ads, graphics, Flash and Java scripts. The remaining content of each page is categorized, classified and itemized. Through what terms are used on the web sites 120, the web summary database 74 determines the frequency 122 that a term 124 has appeared on the web sites 120. For example, the web summary knowledge database 74 may contain a summary of the Amazon.com web site and may determine the frequency that the term golf appeared on the web site.

FIG. 7 depicts the conceptual knowledge database unit 76. The conceptual knowledge database unit 76 encompasses the comprehension of word concept structure and relations. The conceptual knowledge unit 76 understands the meanings 130 of terms in the corpora and the semantic relationships 132 between terms/words.

The conceptual knowledge database unit 76 provides a knowledge base of semantic relationships among words, thus providing a framework for understanding natural language. For example, the conceptual knowledge database unit may contain an association (i.e., a mapping) between the concept “weather” and the concept “city”. These associations are formed by scanning web sites, to obtain conceptual relationships between words and categories, and by their contextual relationship within sentences.

FIG. 8 depicts the user popularity database unit 78. The user popularity database unit 78 contains data compiled from multiple users' histories that has been calculated for the prediction of likely user requests. The histories are compiled from the previous responses 142 of the multiple users 144 as well as from the history 146 of the user whose request is currently being processed. The response history compilation 146 of the popularity database unit 78 increases the accuracy of word recognition. This database makes use of the fact that users typically belong to various user groups, distinguished on the basis of past behavior, and can be predicted to produce utterances containing keywords from language models relevant to, for example, shopping or weather related services.

The preferred embodiment described within this document is presented only to demonstrate an example of the invention. Additional and/or alternative embodiments of the invention will be apparent to one of ordinary skill in the art upon reading this disclosure.

It is claimed:

1. A computer-implemented system for speech recognition of a user speech input that contains a request to be processed, comprising:
a speech recognition engine that generates recognized words from the user speech input;
a grammatical models data store that contains word type data and grammatical structure data, said word type data containing usage data for pre-selected words based upon the pre-selected words' usage on Internet web pages, said grammatical structure data containing syntactic models and probabilities of occurrence of the syntactic models with respect to exemplary user speech input,
an understanding module connected to the grammatical recognition data store and to the speech recognition engine that applies the word type data and the syntactic models to the recognized words to select which of the syntactic models is most likely to match syntactical structure of the recognized words,
said selected syntactic model being used to process the request of the user speech input.
